(19) United States
(12) Patent Application Publication
(10) Pub. No.: US 2002/0015060 A1
(43) Pub. Date: Feb. 7, 2002

(54) Apparatus and method of use and doing business for compiling and communicating statistics

(76) Inventor: William Honjas, Reno, NV (US)

Correspondence Address: Ian F. Burns, P.O. Box 20038, Reno, NV, 89515-0038, US

(21) Appl. No.: 09/885,756

(22) Filed: Jun. 19, 2001

Related U.S. Application Data
(60) Provisional application No. 60/212,516, filed on Jun. 19, 2000.
(60) Provisional application No. 60/223,543, filed on Aug. 4, 2000.
(60) Provisional application No. 60/214,045, filed on Jun. 26, 2000.

(51) Int. Cl. G09G 5/00

(52) U.S. Cl. 345/748

(57) ABSTRACT

The present specification discloses a method and apparatus for a web-centric statistics service and related hardware sales activities, most preferably for use in connection with collection, compilation, analysis, display, and communication of sports statistics. The apparatus includes a dedicated hand-held computing PDA apparatus with modular, removable, activity-dedicated statistics program cartridges, modular, removable save cartridges, an RF transceiver, a modem, and other communication ports. The hand-held computing apparatus can communicate with other such apparatus and with PCs and input/output devices, and the hand-held computing apparatus and other PCs running compatible programs can upload statistics and multimedia to a centralized statistics web site provided by the service operator. The centralized web-site provides dedicated web pages for each user of the statistics program cartridges who registers with the site, and provides a vehicle for third parties to use conventional web browsers to view statistics and other multimedia uploaded to the centralized web site by users. The centralized web-site also may provide advertising and e-commerce services to users and multimedia culling services in order to generate web-casts or other broadcasts or distribution of the multimedia uploaded to the site.

### CROSS REFERENCE TO RELATED APPLICATIONS

This application claims priority through the applicant's two provisional applications: (i) Serial No. 60/212,516, filed Jun. 19, 2000, entitled COMPLETELY INTEGRATED VERTICAL SYSTEM FOR RECORDING, COMPILING, ANALYZING, VISUALIZING, AND COMMUNICATING SPORTS STATISTICS AND OTHER INFORMATION IN REALI-TIME; and (ii) Serial No. 60/223,543, filed Aug. 4, 2000, entitled INTERGRATED APPARATUS, SYSTEM, AND METHOD FOR RECORDING, COMPILING, CALCULATING, ANALYZING, VISUALIZING, AND COMMUNICATING SPORTS STATISTICS AND OTHER INFORMATION, the disclosures of both of which applications are incorporated herein by reference.

### FIELD OF THE INVENTION

This present invention relates to apparatus and methods of use and doing business for compiling statistical information. More particularly, this invention relates to apparatus and methods of use and doing business in recording, compiling, analyzing, visualizing, and communicating statistics, particularly popularly utilized statistics such as sports statistics for example.

### BACKGROUND

Recording, compiling, analyzing, visualizing, and communicating statistics has long presented a formidable challenge. This is particularly true in the field of sports statistics, which has long been an enormously popular in the United States and elsewhere.

In connection with baseball, for example, innumerable fans have long been fanatical about compiling, using, analyzing, and communicating sports statistics. The statistics might be as simple as the number of runs earned by a team in a particular game or the number of games won or lost by a team during a season, and can be more complicated individual and team statistics involving calculations of runs-batted-in, batting-averages, earned-run-averages, etc. Baseball fans thrive on these statistics and their use. Baseball coaches and players often depend on them for their livelihood. Sports reporters, newspapers, sports magazines, and radio and television networks also build nearly entire businesses around the compilation, analysis, and communication of such statistics.

Baseball is merely an example of this phenomena. Statistics are equally important in many other sporting arenas, such as football, basketball, hockey, snow-ski or snow-board racing, soccer, track and field, gymnastics, and horse, motorcycle, bicycle, or car racing.

In the past, sports statistics most often have been compiled with pencil and paper or pre-arranged statistics “scorebook” such as the Stat Master by Champ. In this fashion, scorekeepers, coaches, fans, parents, etc., manually record and keep track of desired statistical data during a game or practice. Later, or perhaps during an event, someone could then calculate the various desired statistical averages, etc., from the data collected. Obviously, this manual entry and calculation system quite often provides a daunting task, particularly when done on a large scale by, for example, coaches for many games, leagues for all their teams, or news reporters or reporting systems for many different players, teams, games, or leagues.

Clearly, the arrival of the computing calculator long ago greatly helped to speed up this sports statistics gathering, use, and reporting process. That process still involves, however, substantial and cumbersome manual data collection, inputting, and/or recording systems. Sharing of the statistical data and compiled statistics among the various users and statisticians has been even more cumbersome, particularly when accomplished with the largely manual prior art statistics systems and methods of using the resulting statistics and information.

Along with the rise of the personal computer, the Internet, the laptop computer, and the personal desktop assistant, many products and systems have been developed or at least disclosed or advertised for the purpose of recording, compiling, analyzing, and/or communicating statistics—sports statistics in particular. Examples of such apparent prior art disclosures (filed herewith and available on the Internet as of the priority date for this specification) include:

1. Baseball-Softball Scorebook: a baseball and softball scorebook available over the Internet.

2. Baseball Scorebook: software for entering and viewing baseball statistics displayed on a personal computer or laptop.

3. All Stats: software for entering, compiling, and printing sports statistics data, notes, and charts and rosters on a PC or laptop (or receiving it from third party applications such as Score Pad noted below) for a limited number of major sports such as baseball, hockey, volleyball, basketball, soccer, and football; this software also allows for uploading of HTML formatted statistics to an Internet Web page or transferring statistics among computers via conventional PC diskette storage systems.

4. Blue Ribbon Software: similar to the All Stats software and also provides synchronization of statistics among networked or interconnected PCs or laptop computers.

5. Teamanizer Software: similar to the Baseball Scorebook software with enhanced ability to manage sports practices and drills and with ability to allow for uploading of HTML formatted statistics to an Internet Web page or transferring statistics among computers via conventional PC diskette storage systems.

6. Score Pad Software: baseball and softball statistics entry and compiling software that runs on standard Palm™ hand-held devices via plug-in software modules and thereby allows wireless beaming of statistics between Palm™ or other compatible devices such as compatible desktop PCs running compatible ScorePad software; such PCs can then synchronize, manage, and print the statistics and upload HTML web pages of player statistics to an Internet Web site.

7. Turbostats ScoreKeeper Software: similar to the Score Pad system described above.

8. STATSKeeper Software: similar to the hand-held system shown in the Turbostats ScoreKeeper system, but also adapted to run on any Windows CE operating system, such as on PDAs other than Palm™ devices.

9. MyTeam.com: a web-hosting service in which team members and teams are provided with their own web pages to which they can post game schedules, pictures, and other information.

10. Sports On the Go Web Service: a free Web site service that allows users to download select sports news and statistics to a hand-held device or PC.

11. Quick Stats Web Service: a Web site service that allows users to view compiled, calculated, and analyzed sports statistics, with emphasis on professional sporting events.

The patent literature also discloses systems somewhat similar to at least certain of the above disclosures, as well as providing other systems for automation of sports statistics compilation or analysis. Examples include:

1. U.S. Pat. No. 5,337,982, to Villarreal, filed Sep. 3, 1993, entitled “Portable Electronic ScoreKeeping Device”;

2. U.S. Pat. No. 4,977,503, to Rudnick et al., filed Oct. 18, 1988, entitled “Electronic Sports Information Retrieval Device”;

3. U.S. Pat. No. 5,026,058, to Bromley, filed Mar. 29, 1989, entitled “Electronic Baseball Game Apparatus”;

4. U.S. Pat. No. 5,153,826, to Johnson, filed Nov. 28, 1989, entitled “Sports Statistics Calculator”; and

5. U.S. Pat. No. 4,128,893, to Johnson and Dalessio, filed Jan. 13, 1977, entitled “Method of and device for analyzing performances in athletic events.”

The applicant has discovered, however, that the demand for statistics, statistical systems, and related services, and the usefulness of many such services if automated, integrated, and rendered more web-centric and thus widely available and useful to a wide range of users, is far greater than has heretofore been recognized, particularly but not solely in the sports realm. The applicant has therefore recognized that prior art devices or systems such as those described above have not provided an automated device that will accept pre-programmed, plug-in cartridges so that the single computing device can then be used for recording and then automatically compiling, analyzing, visualizing, and widely communicating statistics, particularly sports statistics, through the web or to other computing or display devices. In this regard, the above-noted prior art devices or systems have not done so for any sport, much less a significant number of them.

Also, none of the above-referenced devices or systems have provided any, much less a variety of, pre-programmed, single sport statistics cartridges or other readily swappable software storage media, which could, if desired, be sold through, for example, sporting goods, toy, or software stores or catalogs. In addition, these prior art systems have not provided a web centric business for automatically and seamlessly compiling and communicating world-wide statistics about any individual or team that chooses to place the individual's or team's statistics on the business's web site or sites.

Similarly, these prior art systems, and the related businesses, have not provided such services in conjunction with others that users or customers are likely to find of interest, such as additional information or multi-media posting services, sports entertainment services, or connectivity to, or cooperative interaction with, more traditional sports entertainment delivery systems, such as radio, television, or other video or audio networks or services.

### BRIEF SUMMARY OF THE INVENTION

The applicant has therefore invented novel apparatus, systems, and methods of use and doing business (collectively hereinafter “system”) that themselves utilize a significant variety of inventive aspects and features disclosed herein. The system provides both hand-held and web-centric automated recording, compiling, analyzing, and communicating of sports statistics for all types of users: sports participants, teams, coaches, and any others. It also provides related services such as advertising to the users, audio, video, and image distribution for the users, e-mail and chat services, and related entertainment services.

One aspect of the present system is that it most preferably utilizes a computing hand-held device that preferably utilizes plug-in, pre-programmed software storage media in order to load statistical programming information for at least one particular type of activity or area of study or inquiry. Most preferably, the system utilizes a variety of such storage media as the vehicle for providing a variety of statistical programming packages, such as a variety of statistical analysis packages for a wide variety of sports. Most preferably, the computing device is hand-held, primarily dedicated to use as a statistics computing and communication device, and easily carried around and used to enter data while observing pertinent activities such as a sporting event.

Preferably, the storage media each allow the computing device to input, compile, analyze, and widely communicate statistics for a particular type of activity. In the most preferred embodiment, the storage media and computing device cooperatively provide statistics or other information for automated distribution to a particular central web site or linked group of sites available to third parties so that they too can have access to statistics or other information uploaded to the site by users of the system.

Another aspect of the present system is that it preferably provides additional removable storage media for the hand-held computing device. The removable storage, or “save,” media is preferably used to transfer statistics from a hand-held device to another computing or data processing device.

Yet another aspect of the present invention is that hand-held computing devices utilized with the system preferably include wireless data transfer capabilities. In this manner, statistical information preferably can be transferred wirelessly between users of the hand-held devices or between a hand-held device and other computing devices or data recording, displaying, or printing devices.

A further aspect of the present invention is that it preferably provides a user web site to which users of the system may automatically transfer statistics from their hand-held devices, and other audio, video, and image information, about themselves, their team, and their league. Most preferably, each user has a web page for each sport for which the user has purchased a sports statistics cartridge, and in the event that a particular user has multiple such pages, they are most preferably linked to each other. Most preferably, third parties can access the same web site to view information posted by users.

There are other novel aspects of the present system and its various preferred and alternative features. They will become apparent as this specification proceeds. In this regard, it is to be understood that the scope of the invention is to be determined by the accompanying claims and not by this Brief Summary of the Invention.

### DESCRIPTION OF THE DRAWINGS

The applicant's preferred embodiment of the present system and various preferred or alternative features are shown in the accompanying drawings wherein:

FIG. 1 is schematic view of the applicant's preferred overall web-centric system;

FIG. 2 is a schematic view of the preferred organization of sports statistics web pages provided to users of the present system;

FIG. 3 is first flow chart of the method of operation of the applicant's preferred system;

FIG. 4 is a second flow chart of the method of operation of the applicant's preferred system;

FIG. 5 is a schematic view of the components of the applicant's preferred hand-held computing device used in the preferred system;

FIG. 6 is a schematic view of the components and operation of the PC compatible micro-controller for the preferred hand-held device of FIG. 5;

FIG. 7 is a schematic view showing the interaction of the hardware and software in the preferred hand-held computing device of FIGS. 5 and 6;

FIG. 8 is a schematic view of the preferred method of operation of the centralized statistics web site during registration by the user; and

FIG. 9 is a schematic view of the preferred method of operation of the centralized statistics web site during statistics information uploads to the site by a user.

### DETAILED DESCRIPTION OF THE PREFERRED EMBODIMENTS

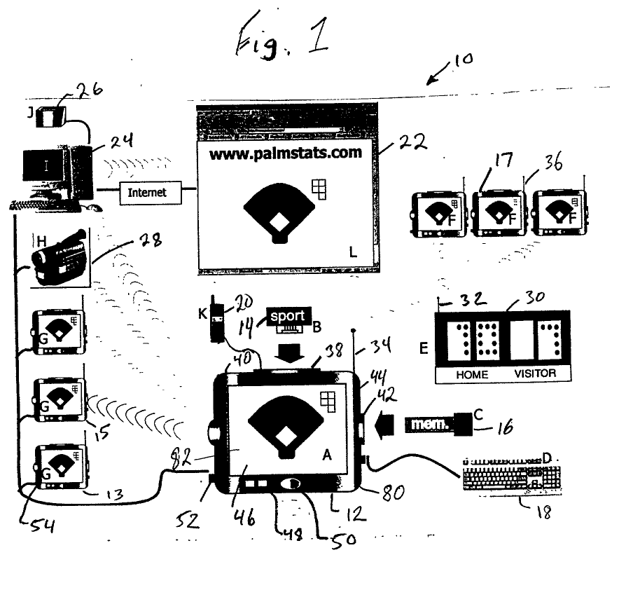

With reference now to FIG. 1, the applicant's preferred embodiment of the invented system, generally 10, provides: one or more hand-held computing devices, e.g., 12, 13, 15, 17; modular, pre-programmed statistics cartridges 14; modular save-cartridges 16; keypad input device(s) 18; cell-phone link(s) 20; a centralized statistics web site 22; personal computer workstation(s) 24 with associated printer or read-write device 26 and audio-video recording and input devices, e.g., 28; and one or more stand-alone display devices, such as a scoreboard 30, with a radio-frequency transceiver 32. Each hand-held computing device, e.g., 12, preferably is dedicated to recording, compiling, analyzing, displaying, and transmitting sports statistics and information in real time to other such computing devices, e.g., 13, 15, 17, to the scoreboard 30, and to the PC workstation 24 through conventional radio frequency transceiver, e.g., 32, 34, 36, associated with each such device 13, 17, 24, 30. The hand-held computing device, e.g., 12, can also connect directly to the Internet web site 22 through the cell-phone 20 link and thereby upload statistics and other information to the site 22 in real-time or otherwise. In addition, the hand-held computing device, e.g., 12, can connect directly to other such devices, e.g., 13, or to other computers, e.g., 24, through conventional wired serial or parallel ports, e.g., 52, 54, the construction and use of which ports is well known to those skilled in the art.

The modular, pre-programmed statistics cartridge 14 is removably insertable into a mating program cartridge drive slot 38 in the upper side 40 hand-held computing device 12 as viewed by a user (not shown) of the hand-held computing device 12. The statistics cartridge 14 most preferably provides the hand-held computing device 12 with statistics programming information for one particular type of sport such as baseball shown in the display 46 of the hand-held computing device 12. In this manner, the user can input statistics information in real time or otherwise through the separate input device 18 or through other conventional PDA input buttons, e.g., 48, 50, the construction and use of which are well known to those skilled in the art.

Similarly, the modular save-cartridge 16 is removably insertable into a mating save cartridge drive slot 42 in the right hand side 44 of the hand-held computing device 12 as viewed by the user. In this fashion, users not only have back-ups of their statistical information but also can use the save-cartridge 16 to transfer data among other devices, PC's, etc.

The scoreboard 30 can receive wireless RF statistics data transfer from a hand-held computing device 12, which might be operated by an umpire or score-keeper/referee during a game. In so doing, all persons attending the game can see official or other scoring statistics in real-time on the scoreboard 30.

The preferred hand-held computing devices, e.g., 12, 13, 17, also have multi-channel RF broadcasting communications capabilities. As a result, they may communicate with each other, by exchanging messages, statistics, etc., through a channel separate from that used for transmission to the scoreboard 30.

It should be noted that, although the hand-held computing device 12 has RF transmission capabilities for linking to the Internet on its own as described above, the hand-held computing device 12 also can link to the Internet through a removable PC Card or cartridge modem (alternatively inserted in the cartridge device slot 38) and the associated cell-phone 20. Such a cell-phone connection provides connecting capability to third-party telecommunications networks to which the hand-held computing device 12 may not have direct wireless access or allow longer-distance communications when the hand-held computing device 12 is too far from its wireless access provider. The cell phone 20 can be replaced with a conventional terrestrial wired POTS system telephone (not shown), thus further extending the wide-ranging communications capabilities of the present system.

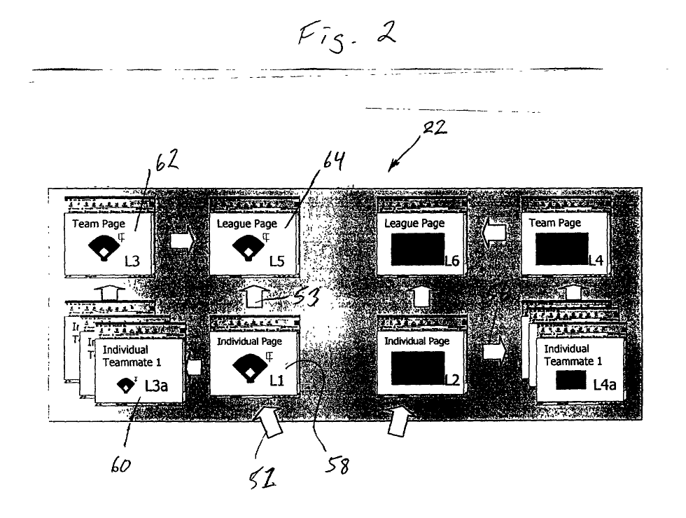

With reference now to FIG. 2, the preferred sports-statistics web site, generally 22, is maintained and operated by the business that sells, as shown in FIG. 1, the hand-held computing devices, e.g., 12, the pre-programmed sports statistics cartridges, e.g., 14, and the save-cartridges, e.g., 16. At the business's one, centralized web site 22, the user can travel (i.e., browse with a conventional Internet browser such as Microsoft Explorer 5.0) from the web site home page 22 through conventional web-page links, e.g., 51, 53 through individual statistics and information pages, e.g., 58, related teammate pages, e.g., 60, related team pages, e.g., 62, related league pages 64, and between and among them 58, 60, 62, 64 in a conventional web page-linking and cross-linking fashion. These links are generally established and maintained as part of the operation of the centralized web site by the preferred business disclosed herein.

Most preferably, information updated on an individual page, e.g., 58, automatically results in automatic updating of all related statistics on all related pages such as related team pages, e.g., 62, or related league pages 64. Similarly, information updated on a team web page, e.g., 62, resulting in automatic updating of related information on related individual web pages, e.g., 60, and league pages, e.g. 64.

The centralized web site 22 preferably automatically establishes individual pages, e.g., 58, as individuals who have purchased a particular statistics cartridge (e.g., a baseball statistics cartridge 14 such as shown in FIG. 1) log-in to the web site 22 and seek to register to upload their statistics to the web site 22. In turn, as multiple teammates thereby log-in to the web site 22 and establish their respective web pages, e.g., 60, the centralized web site 22 automatically establishes and generates a team page, e.g., 62, for the associated teammate web pages, e.g., 60. Then, as multiple team pages, e.g., 62, are established, the web site 64 automatically establishes a related league web page, e.g., 64, for the associated team pages, e.g., 62. On the other hand, a coach or league manager may directly set-up a team or league web site, e.g., 62, 64, and related team member pages, e.g., 60, automatically link to such team or league web site, 62, 64.

Most preferably, the centralized web site 22 also provides audio and/or video webcasts (not shown) accessible through conventional web-casting links (not shown). As explained in greater detail within, the audio or video content for the webcasts is culled from audio or video files uploaded to the web site 22 by individuals, teams, or leagues through their respective pages, e.g., 58, 60, 62, and 64.

Also, the web site 22 and its associated webcasts contain advertisements and marketing information through which the web site operator/business promotes sales of its goods and services and also receives revenue or other remuneration from third-party advertisers and marketing entities. The method of insertion of such advertisements and marketing information into web site 22 banners and webcasts is well known to those skilled in the art.

The web site 22 also most preferably provides individual users, team coaches, etc., with e-mail and live chatting capabilities and web pages (not shown) well known to those skilled in the art. They are further disclosed below.

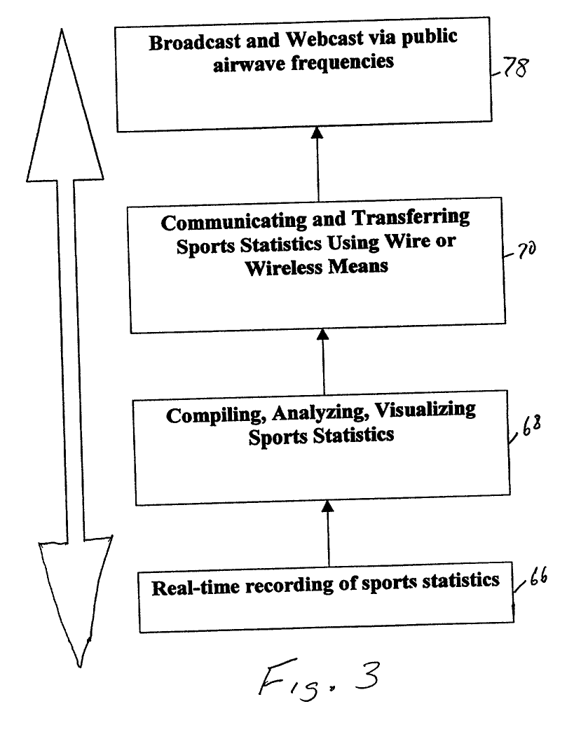

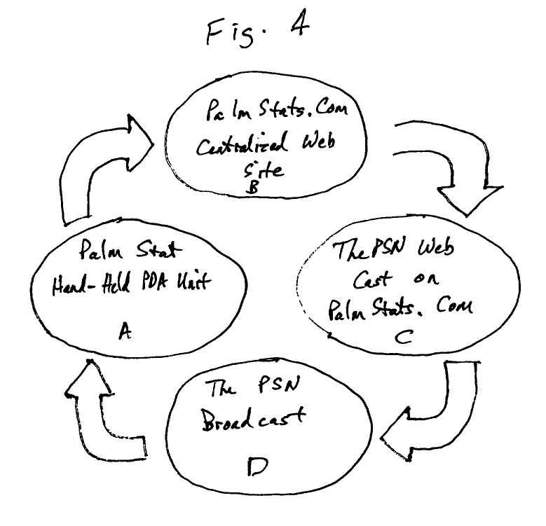

Summarizing, and with reference now to FIGS. 3 and 4, the present novel business model provides real-time (and non-real-time) recording 66 of sports statistics by highly portable hand-held computing device(s) 12 having a sports statistics cartridge 14 preferably tailored to the sport involved. Each such computing device 12 can used to compile, analyze, and visualize the sports statistics data and compilations 68. The computing device 12 may also communicate or transfer the sports statistics to other devices and platforms using wired or wireless means 70. The sports statistics can, in this fashion, be posted to a centralized business web site 74 and broadcast on the web site 76 or by a broadcasting network public or other radio frequency or other transmissions (such as optical transmission through fiber networks) 78.

The novel business method includes procuring revenue, most preferably with an integrated and seamless system, from (i) sales of the hand-held computing device 12 and the sports statistics cartridges 14 and save cartridges 16 either through other entities (such as conventional sporting goods or computing goods stores) or through the centralized web site 74; (ii) sales of advertising on the centralized sports statistics web site 74; (iii) sales of sporting equipment, team management gear, and related entertainment equipment and software through the web site 74; and (iv) sales or charges for webcasts through the centralized sports statistics web site 76 or for conventional broadcasting of content posted to the web site 78. The business model also provides the opportunity for sales of multiple but differing types of sports statistics cartridges to each user, and it includes recurring revenues from advertising revenue and sales of goods of through the web site 74. It also includes recurring revenues in the form of improved or more versatile sports statistics cartridges over time. It also includes the opportunity for the business to sell pre-compiled sports statistics to users on save cartridges, the sales of which provide another source of revenue as noted above.

The purchaser-user of a hand-held computing device 12 and associated sports statistics cartridges can then, through one single web site 74 and associated webcasting capabilities 76: (i) upload statistics, videos, images, or other data related to the user or the user's teammates or the team with which the user is connected; (ii) create a web-page for team-member user or for teams or leagues with which the user is connected; (iii) gain worldwide visibility for the user and the user's team from third parties (coaches, reporters, scouts, fans, etc.) who can access and review the centralized sports statistics web site 74; (iv) procure e-mail services and chat-room access with others of similar sporting interests; (v) procure entertainment in the form of review of others sports statistics or videos, audio, images, or other information provided through the centralized web site 76 and related broadcasting 78; and (vi) purchase sports-related merchandise and find links to other sites of possible interest to those using the centralized web site 74.

Referring back to FIG. 1, the hand-held computing device 12 has a form factor that fits in the palm of a typical adult's hand. The exterior frame 80 is made of rugged plastic, and a liquid crystal touch-screen display 82 is mounted in approximately the frontal center of the frame 80.

Referring now to FIG. 5, a microcontroller board (not shown) is mounted within the exterior frame in a fashion well known to those of skill in the art. Mounted on the microcontroller board is a personal computer compatible microcontroller 84 connected through an ISA bus 86 on the microcontroller board to a radio frequency transceiver 88. In turn, the RF transceiver 88 is connected to a tansceiving antenna 34.

The microcontroller 84 also is connected to the touch-screen liquid crystal display 82 and a conventional Personal Computer Memory Card International Association (“PCMCIA”) type II port, which is equivalent two type I slots, 90, 92. Alternatively, the microcontroller may be connected to two physically separated type I slots 90, 92 respectively mounted within the program cartridge slot 38 and save cartridge slot 42 (as shown in FIG. 1). In either fashion, one of the PCMCIA ports or slots 90 provides a connector for a statistics program cartridge (not shown in FIG. 5, 14 in FIG. 1), and the second PCMCIA port 92 provides a connector for a save cartridge (not shown in FIG. 5, 16 in FIG. 1).

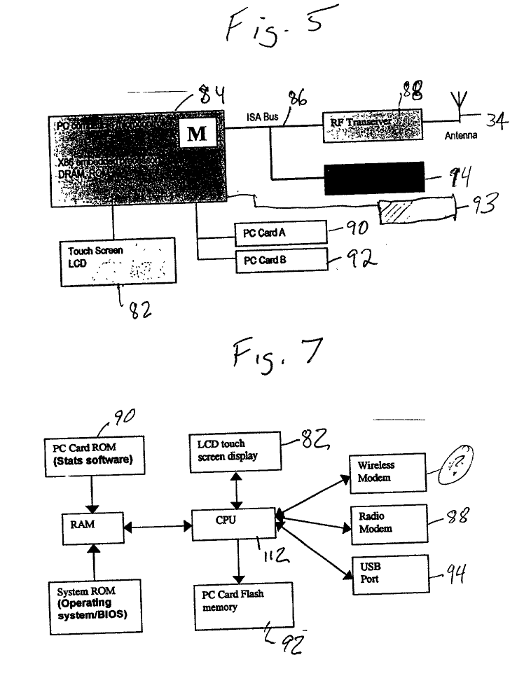

The microcontroller 84 is also connected to an infrared port 93 and a USB controller 94. The microcontroller 84 provides two USB ports 94, one preferably for the keyboard 18 of FIG. 1 and another for the serial port 52 of FIG. 1. The USB ports may also be used to provide connections to video cameras and other input devices in a fashion well known to those skilled in the art. With reference now to FIG. 6, the microcontroller 84 is an AMD ElanSC400 chip running a 32-bit operating system. The AMD microcontroller has an Am486 CPU 112 with 33/66/100 MHz operating frequency capabilities, an 8K write-back cache, and support for up to 4MB of flash system ROM and 16 MB of DRAM. This chip 84 includes an embedded processor 96, an integrated memory unit 98, an LCD controller 100, a PCMCIA Card controller 102, an Enhanced Printer Port (“EPP”) controller 103, a 16550 UART serial port controller 104, an infrared port controller 106, an input interface 108, and an ISA Bus controller 110. The basic capabilities of the AMD microcontroller 84 are enhanced by the addition of: (i) an RF transceiver 88 connected to the serial port 114; and (ii) USBN9603SLB USB controller 94 connected to the ISA Bus controller 110.

The USBN9603SLB USB controller 94 is available from AMD.

The preferred RF transceiver 88 is a Locus OS2400-OEM spread-spectrum radio modem, connected to the controller vial an RS-232 serial data interface port 114. The serial data interface port 114 is, in turn, connected to the serial port controller 104.

The OS2400-OEM modem 88 uses Frequency Hopping Spread Spectrum (FHSS) modulation in the frequency range of 2.4 to 2.4835 GHz. The modem 88 has an operating range of up to 45 meters indoors and up to 3 kilometers outdoors. This spread spectrum operation is license free in the U.S.

A variety of system BIOS and operating system software is available for the Elan SC400 microcontroller 84. The preferred embodiment utilizes the Datalight BIOS without adjustment. The Datalight BIOS development kit, including the assembler/debugger, provides support for the additional modem 88 and USB controller 94 devices. The preferred embodiment utilizes the QNX real-time operating system, produced by QNX Software Systems. This operating system can be loaded into and executed from ROM on the microcontroller 84.

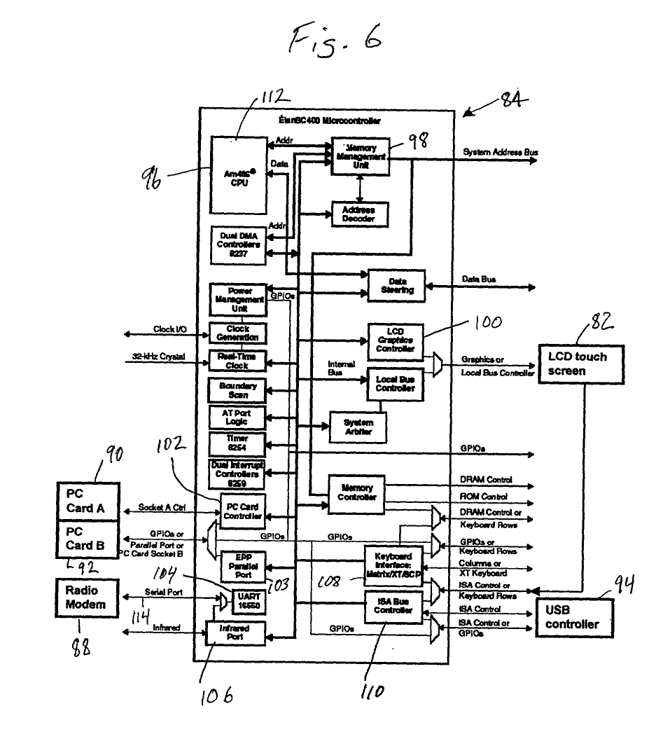

Referring now to FIG. 7, statistical programming software for a given sport is loaded onto ROM on the statistical program cartridge or PC Card 90, which can thus transfer the statistical programming software via the associated PCMCIA slot (not shown in FIG. 7) from the PC Card 90 to RAM 118 on the microcontroller (not shown in FIG. 7, 84 in FIG. 5). This provides several advantages over other software storage solutions, such as lightweight, durability, ease of transfer of data into portable computing devices without software to accomplish the transfer and installation, and dedication of the ROM cartridge to a single statistical program as pre-installed by the manufacturer.

With continuing reference to FIG. 7, sports statistics programs for each PC Card 116 are written in C/C++ and are developed using the uforQNX In-Hand demonstrations system available from AMD, the manufacturer of the microcontroller (not shown in FIG. 7). This demonstration system includes an evaluation board containing the microcontroller's common input/output and communications components. This system is modified to include the added modem and radio transceiver devices in a fashion well known to those skilled in the art. This system also includes a complete QNX RTOS, a microGUI embeddable windowing system, a Photon Application Builder, a TCP/IP developer's toolkit for Internet applications, and a Watcom C/C++ compiler and debugger.

Using these tools, each sports statistic program is written to provide the following functions:

1. record player/team performance;

2. calculate statistical information for the game;

3. view player/team statistics and calculated statistics;

4. manage team activities;

5. upload statistics to centralized web site;

6. view web pages accessed through the centralized web site or elsewhere in web-compatible format; and

7. communicate and exchange data as desired with other devices (wired and wireless as desired by the user).

The type of data recorded for each sport is, of course, at least somewhat unique to the sport. Thus, the user interface is somewhat different for each sports statistics program.

The baseball program, for example, preferably presents the user with a graphical user interface (GUI) on the viewing screen of the hand held computing device. The user can initialize the recording of statistics for a particular baseball game by entering the name of a player, team, or league. As the user observes a baseball game after such an initialization, the screen display prompts the user to enter applicable statistics, such as at-bats, and the statistics recorded with the hand-held display device are preferably automatically updated as the user enters new data during the game.

For example, if a player gets a base hit, and two runs then score as a result, the user enters this information and the player's batting average is automatically updated to reflect those events. More specifically, the user enters the outcome of the at-bat sequence (hit and 2 runs scored) and the local statistics program executes C/C++ commands as follows:

```
Player *p, *currentPlayer;
...
p = currentPlayer;
AtBat(*p);
...
while(p−>hit) {
  p−>hits += 1;
  p−>atBats += 1;
  p−>battingAverage = p−>hits/p−>atBats;
  if (p−>runs>0)
    p−>RBT += p−>runs;
}
```

The statistical data thus compiled are automatically saved to the flash memory save cartridge or PC Card via the PCMCIA slot associated with such cartridge. Conversely, previously saved statistics are read from this flash memory cartridge on initialization of the game statistics program through the game statistics cartridge.

In addition to saving statistical data and compilations, any set of such statistics maintained by the game statistics cartridge and associated save cartridge may be transferred on command to other devices through the wired or wireless output ports and devices on the hand held computing device. For example, in order to access the centralized web site, the statistics program includes software for automated connection either through a modem PC Card inserted into the upper PCMCIA slot in the hand held computing device or by the USB connection in the hand held computing device to a separate computer having an Internet connection. Preferably, the software for accomplishing this connection through the separate computer is sold as an option by the present business.

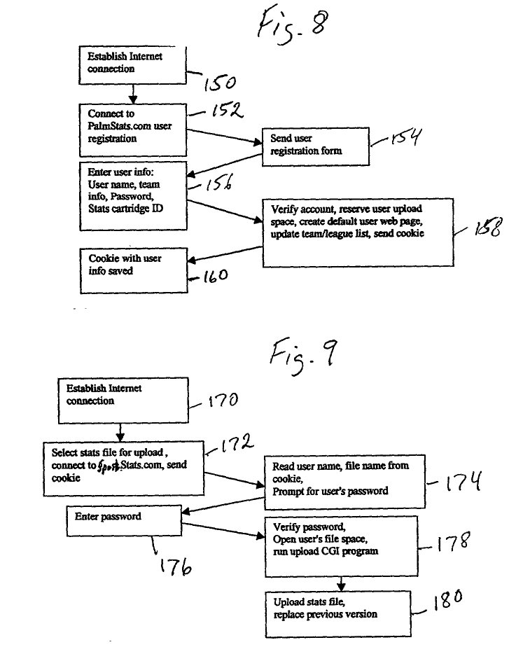

With reference now to FIG. 8, the user establishes an account by first establishing the Internet connection as set for the above 150. The statistics program software then automatically accesses the centralized web site 152. If the user has not already registered, the user first accesses the account registration page 154. In this regard, each sports statistics program contains a unique user identification number, and upon initial log-in and registration, the user enters the identification number and establishes a password to be associated with the identification number of the game statistics cartridge 156. The user is also asked to identify the user's pertinent team information 156. After verification of the information provided by the user 158, the centralized web site automatically provides the user with a dedicated web-page as noted above, dedicated storage space on a server maintained by the centralized web site operator, an e-mail account, and linking association with either a pre-existing team and league or new team and league web pages if none has already been made available to the user by the user's team members or coaches 158. The registration process also preferably places a cookie on the save cartridge in order to facilitate automated file uploads and other transactions with the centralized web site 160.

Once this initial login and account registration takes place, the user can upload statistics and other data to this dedicated storage space for the user. In order to facilitate automated transfers of statistics, the statistics program automatically saves the user-selected data on the save cartridge with a standard file name. Each such file name contains a header with the user name, the creation and modification date and time, the particular sport, the nature of the saved data, the file length, and other attributes if desired. The file name itself also contains a reference to the user name and file type.

With reference now to FIG. 9, the user of the disclosed hand-held computing device thus commences a statistics upload by first selecting a set of statistics for transfer or upload to the centralized web site and then saving the selected statistics to the save cartridge. This step automatically modifies the previously deposited cookie on the save cartridge to identify the name and location of the saved statistics file on the save cartridge in the user's hand held computing device. Then, the user connects to the Internet by the automated connection software provided by the user's sports statistics program 170. The sports statistics program, in cooperation with the centralized web site's automatic accessing of the user information in the previously deposited cookie, automatically connects the user to the user's dedicated web page on the centralized web site and sends the cookie to the centralized web site. The centralized web site then reads the file-location information provided by the cookie 172 and automatically initiates the transfer of the file from the save cartridge to the user's reserved storage space on the centralized web site (such as one labeled “SportsStats.com”) 180.

During this process and whenever the user seeks to access the user's dedicated storage space automatically or otherwise, the centralized web site server protects the user's dedicated storage space from unauthorized access by the htaccess/htpasswd file configuration. Under this system, an .htaccess file is placed in each user's dedicated storage space, and this file causes access requests to the space to require that the user provide the correct password. User names and passwords are stored in the .htpasswd file that accompanies the .thaccess file. When the user accesses the user's dedicated storage space, the centralized web site software reads the user's name from the cookie on the user's hand-held computing device but for security reasons requires the user first to enter the password manually 174.

In the case of an automated upload such as described above, the user enters the user's password 176, and upon verification of the password by comparison to the password for the user in the .htpasswd file, the centralized web site opens the user'dedicated storage space on the web site server and, in cooperation with the statistics program running on the user's hand-held computing device, runs the file upload program for the stored file to be transferred by the user's hand-held computing device 178.

This file upload is accomplished by using the Common Interface Gateway (“CGI”) specification for information transfers between the centralized web site server and the CGI programs. The CGI program, written in Perl, runs on this server in response to requests presented by the user's through the user's web browser provided by the user'sports statistics program on the user's hand-held computing device. In this fashion, the CGI program allows HTML web pages to access data and files on the centralized web site server when they are uploaded or otherwise present on the centralized web site server. It is this CGI program that receives the name of the upload file from the user'cookie referenced above in order to upload the desired file from the user's hand-held computing device.

The CGI program utilizes the following process to accomplish this upload:

```
  $InputDir = “/accounts/baseball/joeplayer”;
$query = new CGI;
#parse stats file path/name on Device
foreach $key query−>param() {
  if ($query−>param($key) =˜ /([\/ \\]+)$/) {
    $Filename = $1;
    $Filename =˜ s/ˆ \.+//;
$File_Handle = $query−>param($key);
  }
}
#open file on server for writing
open(OUTFILE, “>$InputDir\/$Filename”)
#read stats file on Device, write to file on server
while ($Bytes = read($File_Handle,$Buffer,1024)) {
  $Buffer =˜ s/\r/ / g;
  $Bytes = length($Buffer);
  $BytesRead += $Bytes;
  print OUTFILE $Buffer;
}
...
```

Upon completion of this upload process, the user's uploaded statistics are displayed to the user and others on the Web using CGI programs that read the user'statistics files and HTML statistics template files stored on the centralized web site server for the user. The centralized web site server thus dynamically creates the HTML statistics web pages for the user's browser and those of any others as they access a particular user's statistical information for viewing as a web page on the centralized web site. The centralized web site maintains differing HTML template files for each sport.

When a user or other entity accesses a particular team web page maintained by the centralized server, the CGI program displays the team statistical web page in the same fashion as described above and also reads the current registered team member listing file. The CGI program automatically loads each such team member's statistics files from the respective dedicated storage spaces on the centralized web site server in order to produce a team statistics page that includes the statistics of all registered team members as well as any other team statistics uploaded to the centralized web site server by, for example, a registered team coach. Similarly, when league pages are loaded, the league CGI program reads the particular league team list file and displays team statistics for all registered teams for that league.

The CGI program for displaying HTML files of statistics information is a link form a user', team', or league's web page (as applicable) maintained on the centralized web site server. The HTML code for this link includes the following code:

<A HREF=“/cgi-bin/baseballstats.cgi/name=joeplayer/statsfile=joeplayerstats”>

When the user, coach, or third party (“browsing party”) clicks on this link, the centralized web site server runs the CGI program for the link. In the case of a baseball oriented web page for example, the CGI program is named “baseballstats.cgi.” This program procures the applicable statistics file name from the parameter name in the link, opens the applicable team member's (or team's or league's) statistics file stored on the centralized web site server, and defines array values for each type of statistic in the statistics data file. This program then opens an HTML statistics display file for the user (or team or league) and sport involved and parses the contents using the Perl “eval” command. This HTML statistics display file contains embedded Perl variables for each type of valid statistic for the sport and web page involved at this stage, and the “eval” command replaces the variables with the statistical data provided by the user's (or team's or league's) opened statistics file. The centralized web site server then sends to the browsing party the new HTML statistics display file that has thus been generated.

The following Perl programming fragments illustrate commands in the baseballstats.cgi program above:

```
#parse search parameters
read(STDIN, $buffer, $ENV{‘CONTENT_LENGTH’});
@pairs = split(/&/, $buffer);
foreach $pair (@pairs) {
  ($name, $value) = split(/=/, $pair);
  $value =˜ tr/+/ /;
  $value =˜ s/%([a-fA-F0-9] [a-fA-F0-9])/pack(“C”,
    hex($1))/eg;
  $FORM{$name} = $value;
}
#get files to search
$basedir = ‘/accounts/baseball/’;
chdir($basedir);
foreach $file (@files) {
  $1s = ‘1s $file’;
  @1s = split (/\s+/,$1s);
  foreach $temp_file (@1s) {
    if (−d $file) {
      $filename = “$file$temp_file”;
      if (-T $filename) {
        push(@FILES,$filename);
      }
    }
    elsif (-T $temp_file) {
      push(@FILES, $temp_file);
    }
  }
}
#search files
@terms = split(/\s+/, $FORM{‘terms’});
foreach $FILE (@FILES) {
    open(FILE, “$FILE”);
    @LINES = <FILE>;
    close(FILE);
    $string = join(‘ ’,@LINES);
    $string =˜ s/\n//g;
    foreach $term (@terms) {
      if (!($string =˜ /$term/i)) {
        $include{$FILE} = ‘no’;
        last;
      } else {
        $include{$FILE} = ‘yes’;
    }
}
}
#send HTML results page to browser
foreach $key (keys %include) {
    if ($include{$key} eq ‘yes’) {
      print “<li><a href=\“$baseur1$key\”>
        $titles{$key}</a>\n”;
    }
}
```

As noted above, registered users of the centralized web site service also can upload multimedia files in addition to statistics files within the user's file-size limitations imposed by the centralized web site for the particular user. This is accomplished using the same upload procedure described above, but may involve transferring from the a personal computer workstation as noted above rather than the user's hand-held computing device.

These multimedia files may be in the form of video, audio, or images and are simply uploaded into the user's file space and then automatically listed separately on the user's web page provided by the centralized web site service. These multimedia files are accessed in conventional fashion by a browsing party's web browser software. Most such browser software and conventional media player plug-ins can display images and play audio and video files in many popular formats. Some examples include JPEG and GIF for image files and .au, .wav, MPEG, and .avi for audio or video files.

In order to provide a registered user with e-mail service, the centralized web site has an e-mail server running in conjunction with the web site. The identity of this e-mail server is maintained on the centralized web site domain name system (“DNS”) server. This e-mail server controls the sending and receiving of all e-mail by all registered users and maintains a dedicated file system for storage of incoming mail. This server runs a conventional web-based e-mail interface, provided by a CGI program, to allow users to access and generate and send mail through the e-mail interface. The preferred embodiment utilizes the D-Mail program, available from NetWin Limited (netwinsite.com), to provide this e-mail interface and program. The preferred embodiment also utilizes the CWMail add-on program to provide a robust Web based interface to the e-mail server.

The centralized web site also provides browsing parties with a site search function accessible in conventional fashion through each browsing party's browser. This search function consists of a Perl CGI program that first parses the search parameters provided by the browsing party through its browser, then searches the files stored on the centralized file server's user storage areas, and finally displays the search results on the user's browser. This search program includes the following code:

```
#get and parse user and file name parameters
$params=$ENV{‘QUERY_STRING’};
foreach (split(‘&’, $params)) {
  ($name, $value) = split(‘=’, $_, 2);
  $name=˜ s/%(. .)/chr(hex($1))/ge;
  $value=˜ s/%(. .)/chr(hex($1))/ge;
  $params{$name} .= $value;
}
$Name = $params (name);
$Statsfile = $params (statsfile)
$Path = “\/accounts\/baseball\/$Name”;
#read and parse stats contained in the stats file
if (defined($Statsfile) &&
  open(STATSFILE, “<$Path\/$Statsfile”)) {
  $statsdata = <STATSFILE>;
  close (STATSFILE);
  foreach (split(‘&’, $statsdata)) {
    ($name, $value) = split(‘=’, $-, 2);
    $stats($name) = $value;
  }
}
#read HTML template, and use eval to create a new
#version containing the stats vaues
$StatsTemplate =
  “/templates/baseball/playerstats.html”
if (open(TEMPFILE, “<$StatsTemplate”)) {
  $_ = <TEMPFILE>;
  close (TEMPFILE);
  print “Content-type: text/html\n\n” . eval
    “\”$_\“”;
}
```

The centralized web site also provides a browser-based chat capability for registered users. This capability is implemented through third-party programs written in Java, Perl, Perl/Javascrip, or C/C++. The chat program should provide basic capabilities such as user registration, user login, message posting, message administration, and user administration.

The preferred chat program is ParaChat, a Java-based software program available from Paralogic Software (www.parachat.com). Parachat provides advanced web-based chat features on a single web page. Parachat also allows its chat functions to be combined with other content on a single web page and is scalable. It can be configured to accommodate an unlimited number of users provided the centralized web site provides sufficient supporting resources, such as server hardware.

In the preferred system and methods, the centralized web site and business is operated in conjunction with a marketing component to provide exposure to possibly interesting or noteworthy sports performances of registered users, teams, leagues, etc. This marketing system preferably includes automated searching of stored statistical data in order to locate and rank particularized performance information of users, teams, and leagues. This searching is performed at regular intervals using the creation data of stored statistics files as the search criterion. Search times can be minimized as the system grows by shortening the intervals between such searches. This automated searching function includes a ranking system for each sport in order to evaluate the overall rank of the statistics in each stored user, team, and league file. Season and game statistics are preferably ranked separately. The resulting ranking can be accessed by browsing parties through their browsers and utilized by the marketing arm of the operator of the centralized web site service in order to promote the rankings or users, teams, or leagues having the highest or most interesting rankings, etc. The ranking for each user can also written to a file header for each user's statistics program when they access the centralized web site system, thus providing the user with an automated fashion of viewing the user's ranking on the user's hand-held computing device.

The centralized web site operator also may scan the uploaded image, audio, and video files for content of particular interest to browsing parties or others. The web site operator may then organize this content for presentation of the content through the centralized web site or through broadcasting services such as ESPN.

The apparatus and methods described herein consist of the applicant's preferred embodiment. In this regard, it is to be understood that the baseball oriented game programming and statistical systems and business described above are merely exemplary of activities that the present system and business may accommodate. The disclosed apparatus and methods and systems may be, and preferably are, readily adapted and/or used as disclosed to provide similar statistical processes, information, entertainment, and/or web or communication services (including statistics recording, compiling, analyzing, and communicating, and related revenue generation methods as noted above) for many other activities, including sports and others of sufficient interest to a segment of the consuming public.

It can thus be seen that the applicant's preferred embodiments disclosed herein provide a unique statistics, most preferably sports statistics, web-centric service, apparatus, and method of doing business. This service and apparatus provides users with significantly enhanced ability to collect, record, compile, analyze, and communicate statistics. They also significantly enhance the ability of users to distribute other multimedia associated with the users or their statistics, and to promote the users or others. The apparatus for collecting the statistics data is uniquely flexible, providing wired or wireless communication with many other devices or services, including the Internet and its web. The structure of the apparatus also provides significantly enhanced revenue opportunities for the web-centric business involved in providing the service and apparatus, including by sales of the statistics hand-held computing devices, dedicated statistics program cartridges, and the additional save cartridges. The web-centric statistics business also has significant revenue opportunities, including by providing advertising, e-commerce, and data and multimedia content sales or service revenues. The preferred systems and methods thus provide a uniquely integrated, automated, ubiquitous, economical, and vertical statistics and multimedia compilation, analysis, and communication service

It is also to be understood that the scope of the applicant's invention is to be determined by reference to the accompanying claims.

What I claim is:

1. A method of providing centralized statistics services of the type that can be Internet web centric and thereby widely accessed through the Internet web, the method comprising the steps of:
A. Providing a centralized Internet web site;
B. Distributing portable hand-held statistics recording devices to a plurality of third party statistics recording entities;
C. Providing said third party statistics recording entities with user storage in connection with the centralized Internet web site;
D. Providing said third party statistics recording entities with access to the centralized web site and user storage whereby said third party statistics recording entities may connect directly to an Internet telecommunications access service and transfer statistical data directly from said portable hand-held statistics recording devices through said Internet telecommunications access service to said user storage; and
E. Causing the centralized Internet web site to display statistical information based on at least a portion of said of statistical data transferred to said user storage through said Internet telecommunications access service by each said third party statistics recording entities.

2. The method of providing statistics services of claim 1 wherein the display step E includes causing the centralized Internet web site to make a substantial portion of said display of statistical information generally accessible to additional third party Internet web users.

3. The method of providing statistics services of claim 1 wherein: (i) the access step D includes providing said third party statistics recording entities with access to the centralized web site and user storage whereby said third party statistics recording entities may also transfer at least one among an image file, an audio file, or video file to said user storage; and (ii) the method includes step F: causing the centralized Internet web site to provide additional third party Internet users with access to said transferred image file, audio file, or video file from said user storage, whereby said additional third party Internet users may procure, display, or play said transferred image file, audio file, or video file as applicable.

4. The method of providing statistics services of claim 2 wherein: (i) the access step D includes providing said third party statistics recording entities with access to said centralized web site and user storage whereby said third party statistics recording entities may also transfer at least one among an image file, an audio file, or video file to said user storage; and (ii) the method includes step F: causing the centralized Internet web site to provide said additional third party Internet users with access to said transferred image file, audio file, or video file from said user storage, whereby said additional third party Internet users may procure, display, or play said transferred image file, audio file, or video file as applicable.

5. The method of providing statistics services of claim 1 wherein the distributing step B also includes distributing statistics cartridges to said third party statistics recording entities, said statistics cartridges being removably insertable into said portable hand-held statistics recording devices and providing a statistics recording program loadable from said statistics cartridge onto one of said portable hand-held statistics recording devices.

6. The method of providing statistics services of claim 2 wherein the distributing step B also includes distributing statistics cartridges to said third party statistics recording entities, said statistics cartridges being removably insertable into said portable hand-held statistics recording devices and providing a statistics recording program loadable from said statistics cartridge onto one of said portable hand-held statistics recording devices.

7. The method of providing statistics services of claim 3 wherein the distributing step B also includes distributing statistics cartridges to said third party statistics recording entities, said statistics cartridges being removably insertable into said portable hand-held statistics recording devices and providing a statistics recording program loadable from said statistics cartridge onto one of said portable hand-held statistics recording devices.

8. The method of providing statistics services of claim 4 wherein the distributing step B also includes distributing statistics cartridges to said third party statistics recording entities, said statistics cartridges being removably insertable into said portable hand-held statistics recording devices and providing a statistics recording program loadable from said statistics cartridge onto one of said portable hand-held statistics recording devices.

9. The method of providing statistics services of claim 1 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

10. The method of providing statistics services of claim 2 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

11. The method of providing statistics services of claim 3 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

12. The method of providing statistics services of claim 4 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

13. The method of providing statistics services of claim 5 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

14. The method of providing statistics services of claim 6 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing a first web section for display of statistics generated by said first sport statistics recording program and a second web section for display of statistics generated by said second sport statistics recording program.

15. The method of providing statistics services of claim 7 wherein: (i) the statistics cartridge distribution step B includes providing differing, dedicated types of said statistics cartridges for said third party statistics recording entities, at least one said type comprising a first sport statistics recording program and at least a second said type comprising a second sport statistics recording program; and (ii) the display causing step E includes providing (a) at least a first web page section type for display of statistics generated by said first sport statistics recording program and (b) at least a second web page section type for display of statistics generated by said second sport statistics recording program.

16. A method of providing sports statistics compilation and communication services for multiple sports, in conjunction with an Internet web site, the method comprising:
A. distributing portable hand-held statistics recording computers to be received among a plurality of users, each such portable hand-held statistics recording computer having a display screen, a first cartridge mounting slot, and a modem port;
B. distributing a plurality of types of sport statistics program cartridges to be received among said plurality of users, each of the plurality of types of sport statistics program cartridges being removably insertable into said first cartridge mounting slot on each said portable hand-held computing device, and the plurality of sports statistics cartridges including at least first sport statistics program cartridges, second sport statistics program cartridges, and third sport statistics program cartridges;
C. providing a sports statistics display web site having first sport statistics display pages, second sports statistics display pages, and a third sports statistics display pages;
D. providing said plurality of users with access to data storage in conjunction with said web site whereby each of said users may upload first sport statistics, second sports statistics, and third sports statistics from one or more of said modem ports to said first sport statistics display pages, said second sport statistics display pages, and said third sports display pages respectively; and
E. providing additional third party web browsers with access to said first sports statistics display pages, said second sports statistics web pages, and said third sports statistics web pages.

17. The method of providing sports statistics services of claim 16 wherein each said portable hand-held statistics recording computer also has a wireless transceiver mounted to the portable hand-held statistics recording computer, whereby each said hand-held statistics recording computer may communicate with other portable hand-held statistics recording computers.

18. The method of providing sports statistics services of claim 16 wherein each said portable hand-held statistics recording computer also has a second external device port mounted to the portable hand-held statistics recording computer, whereby each said hand-held statistics recording computer may exchange data with at least one external computer and other external peripheral devices.

19. The method of providing sports statistics services of claim 17 wherein each said portable hand-held statistics recording computer also has a second external device port mounted to the portable hand-held statistics recording computer, whereby each said hand-held statistics recording computer may exchange data with at least one external computer and other external peripheral devices.

20. The method of providing sports statistics services of claim 16 wherein each said sports statistics recording computer also has a second cartridge mounting slot and the method includes step F: distributing a plurality of save cartridges to be received among said users, each said save cartridge being removably insertable into said second cartridge mounting slot, whereby each of said users may save statistics data, recorded with a sports statistics recording computer, on at least one of said save cartridges.

21. The method of providing sports statistics services of claim 17 wherein each said sports statistics recording computer also has a second cartridge mounting slot and the method includes step F: distributing a plurality of save cartridges to be received among said users, each said save cartridge being removably insertable into said second cartridge mounting slot, whereby each of said users may save statistics data, recorded with a sports statistics recording computer, on at least one of said save cartridges.

22. The method of providing sports statistics services of claim 18 wherein each said sports statistics recording computer also has a second cartridge mounting slot and the method includes step F: distributing a plurality of save cartridges to be received among said users, each said save cartridge being removably insertable into said second cartridge mounting slot, whereby each of said users may save statistics data, recorded with a sports statistics recording computer, on at least one of said save cartridges.

23. The method of providing sports statistics services of claim 19 wherein each said sports statistics recording computer also has a second cartridge mounting slot and the method includes step F: distributing a plurality of save cartridges to be received among said users, each said save cartridge being removably insertable into said second cartridge mounting slot, whereby each of said users may save statistics data, recorded with a sports statistics recording computer, on at least one of said save cartridges.

24. The method of providing sports statistics services of claim 16 wherein the portable hand held statistics recording computer in cooperation with a sports statistics program cartridges has an automatic Internet connection software, file transfer software, and Internet web browser software loadable into a microcontroller on the portable hand held statistics computer, whereby the hand held statistics recording computer may automatically (i) connect to the Internet, (ii) browse to the centralized web site, and (iii) transfer statistics to the centralized web site.

25. The method of providing sports statistics services of claim 17 wherein the portable hand held statistics recording computer in cooperation with a sports statistics program cartridges has an automatic Internet connection software, file transfer software, and Internet web browser software loadable into a micrcontroller on the portable hand held statistics computer, whereby the hand held statistics recording computer may automatically (i) connect to the Internet, (ii) browse to the centralized web site, and (iii) transfer statistics to the centralized web site.

26. The method of providing sports statistics services of claim 19 wherein the portable hand held statistics recording computer in cooperation with a sports statistics program cartridges has an automatic Internet connection software, file transfer software, and Internet web browser software loadable into a microcontroller on the portable hand held statistics computer, whereby the hand held statistics recording computer may automatically (i) connect to the Internet, (ii) browse to the centralized web site, and (iii) transfer statistics to the centralized web site.

27. The method of providing sports statistics services of claim 21 wherein the portable hand held statistics recording computer in cooperation with a sports statistics program cartridges has an automatic Internet connection software, file transfer software, and Internet web browser software loadable into a microcontroller on the portable hand held statistics computer, whereby the hand held statistics recording computer may automatically (i) connect to the Internet, (ii) browse to the centralized web site, and (iii) transfer statistics to the centralized web site.

28. The method of providing sports statistics services of claim 23 wherein the portable hand held statistics recording computer in cooperation with a sports statistics program cartridges has an automatic Internet connection software, file transfer software, and Internet web browser software loadable into a micrcontroller on the portable hand held statistics computer, whereby the hand held statistics recording computer may automatically (i) connect to the Internet, (ii) browse to the centralized web site, and (iii) transfer statistics to the centralized web site.

29. A portable hand-held sports statistics computing apparatus of the type that may be used to compile sports statistics at a sporting event, the portable hand-held sports statistics computing apparatus comprising in combination:
A. a housing;
B. a microcontroller mounted within the housing;
C. a screen display mounting within the housing in communication with the microcontroller;
D. a first removable cartridge slot in the housing in communication with the microcontroller;
F. a second removable cartridge slot in the housing in communication with the microcontoller;
G. a wireless transceiver mounted within the housing in communication with the microcontoller;
H. at least one second communications port mounted within the housing in connection with the microcontroller; and
I. a first sport statistics recording and compiling program cartridge removably mounted within the first removable cartridge slot.

30. The portable hand-held sports statistics computing apparatus of claim 29 also having a statistics save cartridge removably mounted within the second removable cartridge slot.

31. The portable hand-held sports statistics computing apparatus of claim 30 also having a telecommunications modem cartridge removably mounted within the second removable cartridge slot.

32. A method of doing an Internet web-centric statistics compilation, display, and communication business, the method comprising the steps of:
A. providing a centralized statistics uploading and display Internet web site;
B. distributing, for remuneration, a variety of differing types of dedicated activity removable program cartridges;
C. distributing, for remuneration, a plurality of data save cartridges;
D. providing access to the centralized web site to consumers that have acquired one or more dedicated activity removable program cartridges;
E. causing the centralized statistics uploading and display web site to display activity statistics uploaded to the centralized statistics uploading and display web site by or for said consumers; and
F. providing advertising, for remuneration, on said centralized statistics uploading and display web site.

33. The method of doing web-centric business of claim 32 also including step G: causing the centralized statistics uploading and display web site to display multimedia information uploaded to the centralized statistics uploading and display web site by or for said consumers.

34. The method of doing web-centric business of claim 32 also including step G: distributing, for remuneration, portable hand-held statistics recording, display, and communication computing devices.

35. The method of doing web-centric business of claim 33 also including step H: distributing, for remuneration, portable hand-held statistics recording, display, and communication computing devices.

36. The method of doing web-centric business of claim 32 also including step G: selecting information uploaded to said centralized statistics uploading and display web site for segregated broadcasting or playing or displaying on said centralized statistics uploading and display web site.

37. The method of doing web-centric business of claim 33 also including step H: selecting information uploaded to said centralized statistics uploading and display web site for segregated broadcasting or playing or displaying on said centralized statistics uploading and display web site.

38. The method of doing web-centric business of claim 34 also including step H: selecting information uploaded to said centralized statistics uploading and display web site for segregated broadcasting or playing or displaying on said centralized statistics uploading and display web site.

39. The method of doing web-centric business of claim 33 also including step I: selecting information uploaded to said centralized statistics uploading and display web site for segregated broadcasting or playing or displaying on said centralized statistics uploading and display web site.

40. The method of doing web-centric business of claim 32 wherein the activity is a particular sports activity.

41. The method of doing web-centric business of claim 33 wherein the activity is a particular sports activity.

42. The method of doing web-centric business of claim 34 wherein the activity is a particular sports activity.

43. The method of doing web-centric business of claim 35 wherein the activity is a particular sports activity.

44. The method of doing web-centric business of claim 36 wherein the activity is a particular sports activity.

45. The method of doing web-centric business of claim 37 wherein the activity is a particular sports activity.

46. The method of doing web-centric business of claim 38 wherein the activity is a particular sports activity.

47. The method of doing web-centric business of claim 39 wherein the activity is a particular sports activity.
